(19) United States
(12) Patent Application Publication
(10) Pub. No.: US 2006/0288285 A1
(43) Pub. Date: Dec. 21, 2006

(54) Method and system for validating the content of technical documents

(76) Inventors: Fon Lin Lai, Singapore (SG); Ah Hwee Tan, Singapore (SG)

Correspondence Address: FULWIDER PATTON, 6060 CENTER DRIVE, 10TH FLOOR, LOS ANGELES, CA, 90045, US

(21) Appl. No.: 11/438,751

(22) Filed: May 19, 2006

(30) Foreign Application Priority Data
Nov. 21, 2003 (SG) 200307192-5
Nov. 19, 2004 (WO) PCT/SG04/00373

(51) Int. Cl. G06F 3/00

(52) U.S. Cl. 715/708

(57) ABSTRACT

An automatic document validation system that can be trained to extract domain-specific entities and their linguistically-associated physical, abstract or relational properties, as described within an electronic document. Training of the system can be achieved through the provision of a set of example documents representative of the domain and that have been manually tagged by a domain expert in such a way as to identify the various types of entities and their associated set of recordable properties. Together with a domain-specific vocabulary (e.g.. a dictionary), the trained system is then able to automatically process new documents belonging to the same domain and to test the extracted information on any number of content-conditional rules that have been specified by the domain expert as necessary to confirm the completeness and validity of the new documents.

### FIELD OF THE INVENTION

The present invention relates to the validation of the contents of documents, in particular technical documents, through the extraction of information and comparison of the extracted information with a set of rules.

### BACKGROUND OF THE INVENTION

Most information is currently transferred from person to person or place to place in the form of electronic documents or files, and represented primarily as text. Textual electronic documents are highly varied. They range from short pieces of e-mail, bulletin board postings, news articles, legal documents, scientific research papers, complete news magazines or journals, and even whole books or encyclopaedias. Among all these types of documents, one may define a subset that falls under the label of technical documents.

Technical documents are defined herein as documents for which there is a commonly accepted or even formally specified set of rules which apply to such documents. To put it simply, such rules would specify the “who”, “what”, “when”, “where” and “how” of the contents of a technical document. That is to say, the rules would answer questions such as:
“what are the entities that expected to be represented within the document?”
“what are the valid typographical representations of an entity?”
“what are the logical parts of the document, if any?”
“which part of the document should an entity be associated with?”
“in what order, if any, should entities be represented within the document?”
“how are different entities related to each other within the document?”

Whilst it may be said that all documents can have such rules applied to them, there are two facts that are always true of technical documents with respect to such rules, but which are not always true of non-technical documents. These are that:
The failure of a technical document to satisfy one of more such rules definitely indicates the incompleteness or non-validity of the document to a person familiar with the subject matter of the document; and
The satisfaction of all such rules by a technical document definitely indicates the completeness and full validity of the document to a person familiar with the subject matter of the document.

To put it another way, only technical documents have a sufficiently explicit literal structure that can be fully and formally confirmed with a limited list of rules or validation statements, and a unique set of such rules would be guaranteed to be applicable to all technical documents belonging to a particular subject matter.

Examples of technical documents could include:
ingredients lists of manufactured food products;
user manuals of a company's consumer products;
programming instructions of various computer programs written in a programming language;
the hypertext markup language used to create web pages on the world wide web;
chemical data sheets listing the chemical and physical properties of chemical products;
food menus at restaurants;
sales brochures of a company's product line, be it computers, cars, or even houses.

In many industries, technical documents often represent a common and convenient method by which different manufacturers of a class of products allow their customers to compare their products against those of their fellow manufacturers.

Furthermore in established non-cottage industries, there are often one or more governing bodies whose role (among many) is the establishment and possibly enforcement of standards on all producers within their specific industries. These standards could be standards of product quality, workplace safety, and so forth. In the case of governing bodies, technical documents are used to determine a product's compliance with the regulations setting out the standards.

It is often the case that the compliance requirements cover both the completeness of the technical document's contents as well as the standard's compliance of the product that is described within that document. This is because it is only possible to judge a product's compliance with regulations if the information concerning that product (i.e. the contents of the technical document) is complete and accurate to begin with.

The task of determining compliance ultimately falls on one or more personnel within the governing authority, who must have the specialist training needed to know the set of rules that determine compliance (or lack thereof) of a technical document and the product it describes. Indeed, it is often the need of specialist knowledge for comprehending the technical information about a product that restricts normal lay consumers from being able to evaluate the quality of a product competently.

The task (or problem) of assuring completeness of information about a product, as well as its compliance with standards, is thus shifted from the non-expert consumer to the trained (i.e. expert) personnel of a governing body.

A problem remains, however, that experts, by the very fact of their specialist knowledge, tend to be limited in numbers. It would not be humanly possible for a handful of experts to assess the quality of all pieces of information in any substantial market segment, where product varieties can run into the millions, especially with new products constantly being added to the population.

Thus the only practical manual approach to technical document validation is by adopting the method of sampling the population. That is to say, the officers of the governing authority only check a random (or at best semi-random) fraction of all possible technical documents in existence. This means that a majority of technical documents released into a market segment have not been validated before reaching a product's users, and a significant percentage of these will contain wrong or incomplete information that could place users of the product at risk.

Technical document validation is definitely a problem well-suited to having an automated solution applied. The established automated approach to solving this problem is for the experts to “encode” their knowledge, usually in the form of rules, into a specialised computer program which would then “replicate” the experts' analytical process in trying to solve a problem or answer a question (e.g. “is the information in this document correct and complete?”).

In fact, expert systems represent just such a specialised computer program and many are in use today. Prior art in the area of expert systems include: U.S. Published Pat. No. 6,049,794, issued on 11 Apr. 2000, to Jacobs et al., and entitled “System for screening of medical decision making incorporating a knowledge base”; U.S. Published Pat. No. 5,583,758, issued on 10 Dec. 1996, to McIlroy et al., and entitled “Health care management system for managing medical treatments and comparing user-proposed and recommended resources for treatment”; U.S. Published Pat. No. 4,803,641, issued on 7 Feb. 1989, to Hardy et al., and entitled “Basic expert system tool”; and U.S. Published Pat. No. 5,619,621, issued on 8 Apr. 1997, to Puckett, and entitled “Diagnostic expert system for hierarchically decomposed knowledge domains”.

However pure expert systems, such as the above-mentioned, require their input data to be presented in a completely uniform, structured format. They are also traditionally implemented as question answering systems in which a (non-expert) user enters information to be verified or confirmed. In other words, in the domain of document content validation, the user would have to act as the “intelligence” that extracts out corresponding entities within different electronic documents of different layout or formatting structure, and then subsequently present the extracted data in a consistent format to the expert system for evaluation.

So expert systems can only solve part of the problem. For the other part of the problem, which is now the tedious manual labour needed to transcribe a document's contents for an expert system, natural language processing (NLP) offers a solution. Specifically, an NLP system in the form of an information extraction system that is able to learn to identify the significant entities of a specific domain and subsequently to extract such entities out of future same-domain (though not necessarily same-layout) documents that it has never encountered before.

Prior art in the area of information extraction include: U.S. Published Pat. No. 6,263,335, issued on 17 Jul. 2001, to Paik et al., and entitled “Information extraction system and method using concept-relation-concept (CRC) triples”; U.S. Published Pat. No. 5,841,895, issued on 24 Nov. 1998, to Huffman, and entitled “Method for learning local syntactic relationships for use in example-based information-extraction-pattern learning”; U.S. Published Pat. No. 6,212,494, issued on 3 Apr. 2001, to Boguraev, and entitled “Method for extracting knowledge from online documentation and creating a glossary, index, help database or the like”; and International Patent Application Publication No. 01/11,492, published on 15 Feb. 2001, in the name of the Trustees of Columbia University in the City of New York, and entitled “System and method for language extraction and encoding”.

A pure information extraction system, like one of the above-mentioned, does not, in itself, represent a solution to the problem of document content validation. This is because such systems have no ability to judge the correctness of the linguistically-associated values of each entity. That task still requires the contribution of an expert system.

However, simply combining an expert system together with an information extraction system is also not sufficient—expert systems have other properties that make them unsuitable for the problem of automatic document content validation.

One limitation of expert systems that precludes their direct application to the problem domain is that expert systems, by their nature, work by an incremental process akin to fault diagnosis, in which a series of questions and answers between system and user serve to “drill down” to the specific fault to be uncovered. That is to say, a user may start off not knowing all the pieces of information needed by the expert system to perform its diagnosis. This allows the system to provide only a partial solution in the form of an intermediate question to elicit subsequent pieces of information from the user. And so the process is repeated until finally the system has eliminated all possible faults but one.

The key issue with such a process used by expert systems is that it assumes the fault(s) has already been detected (but not yet identified), whereas in the system that is required for the problem domain described, detection of the fault(s) is itself the first task of the system.

Outside of expert systems and information extraction techniques, there is an existing method in US Patent Publication No. 5,987,251, issued on 16 Nov. 1999, to Crockett et al., and entitled “Automated document checking tool for checking sufficiency of documentation of program instructions”. This attempts to overcome the limitations described above. However, this method is meant only to perform content validation on one type of programming instruction at a time. All programming languages share the same property whereby their syntax and grammar are precisely defined. Thus to extract individual grammatical tokens from a piece of program code, all that is required is a dedicated hand-crafted parser to extract all information, fully and correctly, from all pieces of code every time. In contrast, the problem domain that the invention is aimed at solving does not allow for the assumption of an exact syntax and grammar as this is the nature of human languages.

Therefore, existing techniques cannot fulfil the requirements of the problem domain and there remains a need for more sophisticated techniques that are able to perform automatic document content validation to the satisfaction of the requirements analysis for the problem domain described above.

### SUMMARY OF THE INVENTION

According to one aspect of the present invention, there is provided A method for performing content validation on a free-text document. The method extracts a plurality of semi-structured representations from the free-text document. The method applies a logical inference engine to the semi-structured representations. The method interprets the output of the logical inference engine for a consequential action.

According to another aspect of the present invention, there is provided a system for performing content validation on a free-text document. The system comprises extracting means, applying means and interpreting means. The extracting means is operable to extract a plurality of semi-structured representations from the free-text document. The applying means is operable to apply a logical inference engine to the semi-structured representations. The interpreting means is operable to interpret the output of the logical inference engine for a consequential action.

According to a further aspect of the invention, there is provided an automatic document validation system that can be trained to extract domain-specific entities and their linguistically-associated physical, abstract or relational properties, as described within an electronic document. Training of the system can be achieved through the provision of a set of example documents representative of the domain and that have been manually tagged by a domain expert in such a way as to identify the various types of entities and their associated set of recordable properties. Together with a domain-specific vocabulary (e.g.. a dictionary), the trained system is then able to automatically process new documents belonging to the same domain and to test the extracted information on any number of content-conditional rules that have been specified by the domain expert as necessary to confirm the completeness and validity of the new documents.

The invention is able to provide a method and system for applying large logical, relational or quantitative rule bases provided by domain experts, to free or semi-structured technical documents, optionally with one or more large external factual knowledge bases, in order to analyse the validity of the contents of said documents. Validity is assessed in terms of compliance with the predetermined set of rules, as well as through the absence or presence of conflicting or incompatible pieces of content within said documents.

### BRIEF DESCRIPTION OF THE DRAWINGS

Embodiments of the invention will now be described by way of non-limitative examples, with reference to the accompanying drawings in which:

FIG. 1 is a schematic diagram of a document content validation system according to one embodiment of the invention;

FIG. 2 is a flowchart relating to the operation of the system of FIG. 1;

FIG. 3 is a schematic diagram illustrating a typical logical network created from a set of validation rules;

FIG. 4 presents a specific example of a specific logical network created from a specific set of validation rules;

FIG. 5 depicts a schematic diagram illustrating an example of the information extraction portion of the method of FIG. 2 in more detail;

FIG. 6 illustrates the operation of the logical network of FIG. 4 on the extracted information of FIG. 5; and

FIG. 7 is a flowchart illustrating a portion of the overall flowchart of FIG. 2.

### DETAILED DESCRIPTION

A method, an apparatus, and a computer program product for validating the content of technical documents are described. In the following description, numerous details are set forth. It will be apparent to one skilled in the art, however, that the present invention may be practised without at least some of these specific details. In some instances, well-known features are not described in detail so as not to obscure the present invention.

Herein are described embodiments of a method and system for performing automatic content validation of variably-formatted electronic free-text documents, specifying qualitative, quantitative, relational or logical attributes for entities referenced therein within the documents. The system and method recognise and extract a plurality of semi-structured representations from the document, for instance domain-specific entities referenced within a document and the attributes associated with such entities within that document. Human-crafted rules, created by experts within the domain, are applied to the entities and their linguistically-associated values as extracted from each document. The validity of the entity values and relationships are assessed, based on the rules.

An embodiment of the invention is provided with an information extraction (IE) engine that is able to identify the domain-specific entities that are present in a given problem domain, along with the qualitative, quantitative, relational or logical attributes of those entities, within a document. A rule base is also provided. The rule base is represented as a simple list of condition-action clauses, and represents an expert's logical “checklist” when manually validating the contents of a document from the domain.

The “qualitative” attribute of an entity typically means adjectives or descriptive phrases occurring next to a noun entity. For example, in the phrase “a fuel-efficient engine”, the phrase “fuel-efficient” would act as the qualitative attribute of the “engine” entity. While in the phrase “low coefficient of drag”, the term “low” represents the qualitative attribute of the “coefficient of drag” entity.

The “quantitative attribute” of an entity typically means some count of some unit of measurement associated with a noun entity, which may itself represent some measurable quality of another entity. For example, in the phrase “boiling point of 100 degrees Celsius”, the phrase “100 degrees Celsius” represents a quantitative attribute of the “boiling point” entity, which itself should be associated with some other entity. Similarly, in the phrase “sugar: 2 to 3 teaspoons”, the phrase “2 to 3 teaspoons” represents a quantitative attribute of the “sugar” entity.

The “relational attribute” of an entity typically means some comparative or positional term/phrase that forms a relationship between one entity and one or more other entities. For example, in the phrase “emergency cases are given higher priority than non-emergency cases”, the phrase “higher priority than” represents the comparative relational attribute for the entity “emergency cases” with respect to the entity “non-emergency cases”. While in the phrase “part x is connected to part y”, the phrase “is connected to” represents the positional relational attribute for the entities “part x” and “part y” with respect to each other.

The “logical attribute” of an entity typically means some binary state that an entity can be in whereby the truth of one state implies the falsity of the other. For example, in the phrase “water not detected”, the phrase “not detected” represents the logical attribute of the “water” entity.

Where the same reference number appears in more than one Figure, it is being used to represent the same feature or step.

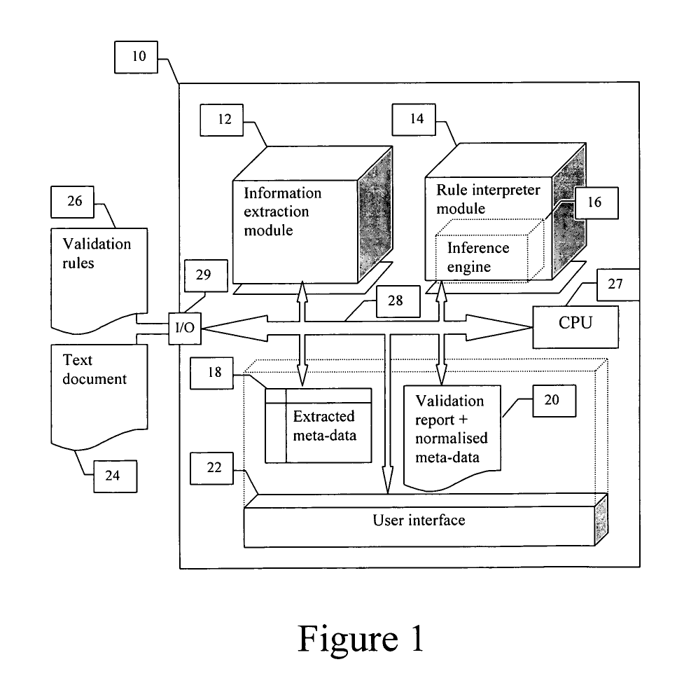

Referring to FIG. 1, this is a schematic diagram of a document content validation system 10 according to one embodiment of the invention. The document content validation system 10 includes an information extraction module 12, a rule interpreter module 14, containing an inference engine 16, an extracted meta-data store 18, a validation report and normalised meta-data store 20 and a user interface 22.

The document content validation system 10 receives input from a free-text document 24 (containing text, one or more images, audio, video or any combination thereof) and in the form of a set of validation rules 26. The document 24 is the document whose content is to be validated. The set of validation rules 26 is provided by a domain expert, or acquired through some automated or semi-automated process. The inference engine 16, a logical network, within the rule interpreter module 14, is automatically constructed based on the set of validation rules 26.

The extracted meta-data store 18 stores intermediate meta-data, representing the information extracted from the document 24 that is being processed. The information extraction module 12 extracts semi-structured information or meta-data from electronic free-text documents 24. The extracted information is retained, temporarily in the extracted meta-data store 18, for further processing by the rule interpreter module 14. The rule interpreter module 14 receives the extracted information from the extracted meta-data store 18. The rule interpreter 14 propagates the extracted meta-data through the inference engine 16, being the internal representation of the set of validation rules 26. The validation report and normalised meta-data stored in the validation report and normalised meta-data store 20 represents the evaluation results of the extracted meta-data 18 by the rule interpreter 14.

Although the various modules of the system of FIG. 1 can be embodied in hardware, the document content validation system 10 of FIG. 1 is embodied on a computer, where the processes are controlled by a processor, here a central processing unit (CPU) 27. The various modules communicate with each other through a main bus 28. The documents 24 and the validation rules are entered through an in/out port 29, onto the bus 28 and to the information extraction module 12 and the rule interpreter module 14, respectively. The extracted meta-data 18 and the validation report and normalised meta-data 20 are stored on the computer memory, which may be volatile or non-volatile. The user interface is typically a screen with a keyboard.

The information extraction module 12 includes an information extraction engine as is well-known in the art, for instance as described in any of previously published patent documents U.S. Pat. Nos. 6,263,335, 5,841,895, 6,212,494 and WO 01/11,492, mentioned earlier, or other systems with similar functionality. The information extraction module 12 uses NLP techniques, in which an ambiguous human grammar is taught (by example etc.) to a computer system.

The information extraction module 12 is responsible for extracting semi-structured representations such as textual entities and their linguistically-associated attributes, from the input electronic document 24. The information extraction (IE) engine is able to identify the domain-specific entities that present in a given problem domain, along with the qualitative, quantitative, relational or logical attributes of those entities, through teaching.

The rule interpreter module includes a rule engine responsible for constructing the inference engine 16 from the external rule set 26. The inference engine 16 evaluates each entity extracted from a document and highlights each entity that fails to satisfy one or more of the rules in the rule set, directly or indirectly, while referencing triggering rules for each point of failure.

Each rule of the set of validation rules 26 may be associated with an easy-to-understand explanation in order to provide a human user with an understanding of the requirements of a failed rule and of the necessary corrections to a document's contents to avoid future subsequent failure of the rule.

The system can work either interactively or non-interactively, validating single documents or validating a number of them in a batch process. For an interactive process, a human operator controls the system through a user interface, feeding electronic documents to the system for validation. He can feed documents one at a time or have them fed through automatically and only get involved when a document is failed and needs correcting. The system processes a document and presents the results of its validation checks performed on the document to the operator via a user interface. The operator can then take appropriate corrective action on the contents of the document and pass it through the system again to confirm that all errors have been corrected and that no new errors have been introduced. After the current document has passed the validation checks, the next document can be passed to the system and the workflow is repeated. In the case of a batch process, the system can be given a listing of many electronic documents that it will then validate one by one, without the assistance of any human operator. For each document that is found to have validation errors, the system will highlight the document within the listing and produce a corresponding log of the validation errors for that document.

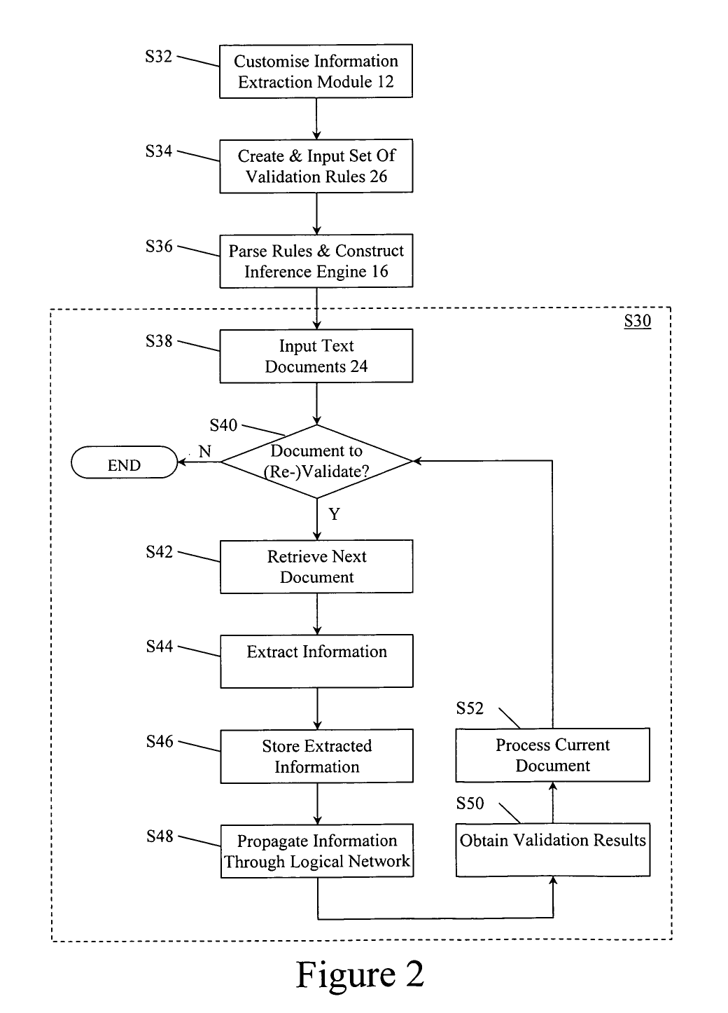

FIG. 2 is a flowchart depicting a document content validation process S30, operated in the document content validation system 10 of FIG. 1, as well as some preparation steps.

In this embodiment, the preparation steps include: customisation of the information extraction module 12 (step S32), creation and input of the set of validation rules 26 (step S34), and parsing of the set of validation rules 26 and construction of the inference engine 16 (step S36). These preparation steps are shown here in one particular sequence, although customisation of the information extraction module 12 (step S32) can occur in parallel with, between or after two steps. Of course the validation rules 26 need to be created (step S34) before they can be parsed (step S36). Further, whilst the preparation steps are shown here as being outside the operation S30 of the document content validation system 10, in other embodiments, one or more of them may be within that process.

The document content validation process S30, in this embodiment involves various further steps, as indicated in FIG. 2. Initially, one or more documents 24 are input (step S38). There is a determination as to whether there are any documents to validate (step S40). If there is none to validate, the process S30 ends. Otherwise, the next document for validation is retrieved (step S42), which in the first run-through is the first document. The information is extracted from that next document (step S44) and stored (step S46). The (stored) extracted information is propagated through the logical network in the inference engine 16 (step S48) to produce validation results which are compiled (step S50). The current document is then processed (step S52), which may involve finishing with the current document or amending it and setting the amended document as the next document. The process reverts to step S40.

Step S32 is a construction stage in which the system is semi-automatically initialised for a particular problem domain. The information extraction engine 12 is customised in to a domain vocabulary, in order to be able to understand or recognise domain-specific entities and their set of logical, relational or quantitative attributes along with the possible values or patterns these attributes may take. Such customisation can take the form of a domain expert providing manually-tagged documents with content characteristic of the domain or, encoding grammatical rules directly into the engine, or other possible operations. For example, in a chemical industry domain, there are many complicated names of chemicals that would be unknown to a basic vocabulary module.

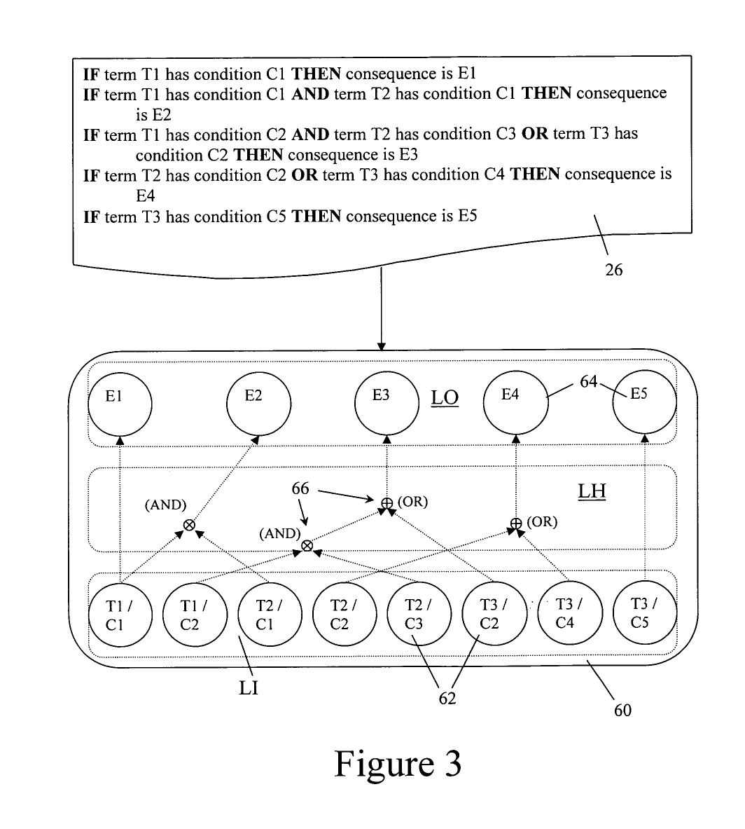

Similarly, the domain expert's participation may also be used to create or author, in step S34, the set of validation rules 26 that will be used to validate electronic documents that are processed by the invention. Alternatively, the rules may be taken from some other authoritative source such as a book. The rules are relevant to the same domain to which the information extraction engine 12 has been customised in step S32. The rules can be in the form of “if-antecedents-then-consequences” (i.e. Conditional) clauses in which “antecedents” represents one of a list of erroneous physical, abstract or relational states associated with one or more entities, and “consequences” represents one of a list of error statements or validation conclusions to be associated with one or more entities, upon affirmation of the “antecedent” conditions. The set of validation rules 26 are written in a restricted English-like syntax, commonly referred to as “IF-THEN” statements, which are described later with reference to FIG. 3. The validation rules are also input into the document content validation system 10 in step S34 and loaded by the system's rule interpreter module 14.

Whilst, in this embodiment, the set of validation rules 26 are written as “IF-THEN” statements, as is mentioned above, other approaches are possible, although on the mathematical logic level, these are generally equivalent. One example is to use state diagrams, where every possible state of the data that a system can encounter is enumerated, along with every possible result that the system can output. A table is formed, for instance with all input states listed along the vertical edge and all output states listed along the horizontal edge. Selected intersections of row versus column are simply marked as “on”, to indicate which output state results from which input state.

In step S36 the system's rule interpreter module 14 parses the set of validation rules 26 and forms an equivalent internal logic network, thereby constructing the inference engine 16.

With the preparation steps S32 to S36 completed (whether at the same time as the later steps or separately, earlier), the system is now in a state in which it can perform content validation repeatedly without further human intervention. New documents related to the same problem domain as the rules specified in step S34, and even in their original form (i.e. not pre-processed to conform to some standard layout/template structure) can be fed to the system. For each document, the system performs information extraction and propagates the associated values of the entities extracted through its rule-base. For all those rules that trigger an error on the extracted document content, the system will display an associated error message through a user interface, together with or alternatively appending the error message to a log file for later perusal by a human operator.

One or more documents are therefore input (step S38) electronically into the content validation system 10, such that their contents can be read. Once it has been determined that there are documents to validate (step S40), the standard process of the document content validation system 10 continues by retrieving the next document to be validated (which is the first document in the first pass through), from the store of documents (step S42). The domain-customised information extraction module 12 is applied to this next document, with relevant information, in the form of entities and relevant attributes of the entities, extracted (step S44). The information extraction results in an internal extracted meta-data representation of the document, which is stored in the extracted meta-data store 18 (step S46).

The extracted meta-data 18 produced by the information extraction engine 12 in step S44, is propagated (step S48) through the logical network 16 constructed by the rule interpreter 14 in step S36. Once the extracted meta-data content 18 has been completely propagated through the logic network 16, in step S48, this produces final states in the various consequence nodes of the logical network 16. The states of the consequence nodes are perused to compile a set of validation results containing a paired list of meta-data groups and failed validation rules (if there are any) (step S50).

Finally, the current document is processed (step S52), based upon the set of validation results. If no validation rules have been failed, that is logged and the current document is finished with. Otherwise, the document may be amended to overcome the information absences or errors that lead to the failure of one or more validation rules, or the failures are recorded and the document set aside for later amendment. If the document is amended within the system, the amended document is then designated as the next document. After step S52, the process returns to step S40, to determine if there are any more documents to validate. If there are, then in step S42 the next document is retrieved. This is the amended previously processed document if it was amended and designated as the next document. Otherwise the document retrieved will be a new one.

FIG. 3 is a schematic diagram illustrating a generalised structure of an example of a validation rule set 26 and a corresponding logical network 60 created from the set 26 of validation rules. This example is generalised, in that the various numbered terms and conditions are not defined, but specific in that particular combinations of the numbered terms and conditions are given specific consequence states. The exemplary logical network 60 is one embodiment of the inference engine 16 constructed by the rule interpreter module 14 of the document content validation system 10 of FIG. 1. The illustrated logical network 60 is a simplified three-layer neural network with:
(i) an input node layer LI containing a number of individual input nodes 62, for representing the individual pieces of meta-data extracted by the information extraction module 12 from the document 24 being validated;
(ii) an output node layer LO containing a number of individual output nodes 64, representing the consequences of each individual rule;
(iii) an intermediate or hidden node layer LH containing a number of individual intermediate nodes 66, representing compound logical operations between multiple input nodes; and
(iv) edges or pathways 58 that connect all the input and output nodes 62, 64 together via the intermediate nodes 66 and following the logic described by the rules in the validation rule set 26.

For each document 24 to be validated, the logical network 60 is first initialised such that there are no active nodes in any of the three layers LI, LH, LO. This represents the initial state in which no validation errors are known to exist prior to validation.

The extracted meta-data exists as entity-attribute pairs, where each unique entity-attribute pair has a direct association with one unique input node 62 in the input node layer LI of the logical network 60, for all entities mentioned in the validation rule set 26. The attribute value of the meta-data then represents the current state or activation value of the current document content. Thus these activation values are propagated from the input node layer LI to the output node layer LO, optionally via some intermediate nodes 66 in the intermediate node layer LH. When all meta-data has been fully propagated through the network, those top-level nodes in the output node layer LO of the logical network 60 that have been activated represent the rule consequences that have been triggered.

Where one or more output nodes LO are activated, the rule interpreter 14 can collate the information related to the nodes by tracing the contributing activation signals back to the responsible input node 62, thus providing a validation report 20 (for instance for a human operator) containing detailed explanations for the failure of any validation rule. Both extracted meta-data and validation outcomes are accessible via the user interface 22, thus allowing a human operator to: review the validation results produced by the rule interpreter 14 and to determine the correction needed to the input document 24 based on these results; and if necessary, return to the information extraction stage (step S44 of FIG. 2) to judge the completeness and correctness of the information extracted by the information extraction module 12.

The validation rule set 26 represents an abstract example of one embodiment of such a set of rules, using a restricted, formalised syntax. In the example validation rule set 26 of FIG. 3, the terms T1, T2 and T3 represent discrete entities that are identified and extracted by the information extraction module 12, together with their given state or associated values within the document. Conditions C1 to C5 represent conditional tests to be performed on specific ones of the terms T1 to T3, usually related to the extracted attributes of the entities (qualitative, quantitative, relational or logical attributes). Such tests may include: checking for the absence or presence of a term itself or an associated property; checking the value range of an associated property of a term; checking for a matching string pattern associated with a term or its associated property, etc. Consequences E1 to E5 are the consequences associated with the failure of a particular rule, which may be as simple as the output of a unique error statement to a log file or to a visual display, for each consequence E1 to E5 activated. A consequence is deemed activated by the logical satisfaction of the pairs of terms and conditions that precede it within a single rule statement.

The generalised set of validation rules 26, in the exemplary embodiment of FIG. 3, as mentioned earlier is in the form of a series of “IF-THEN” statements, which are as follows:

(i) IF term T1 has condition C1, THEN consequence is E1;

(ii) IF term T1 has condition C1 AND term T2 has condition C1, THEN consequence is E2;

(iii) IF term T1 has condition C2 AND term T2 has condition C3 OR term T3 has condition C2, THEN consequence is E3;

(iv) IF term T2 has condition C2 OR term T3 has condition C4, THEN consequence is E4; and

(v) IF term T3 has condition C5, THEN consequence is E5.

Of course they may be other combinations and other “IF-THEN” statements, depending on the overarching rules and requirements of the validation system.

Although not illustrated in the embodiment of FIG. 3, the logical network 60 may also include back pointers from consequence nodes to their triggering term-condition nodes, to allow for the tracing back, and hence reporting, of the term-condition pairs responsible for triggering a consequence.

The expressibility of the rule statements is enhanced by the additional syntactic terms “AND”, “OR” and “NOT”, which allow for the combination of different term-condition pairs to express an overall condition that has greater complicity. The logical meaning of the “AND”, “OR” and “NOT” syntactic tokens are synonymous with those used in normal logic statements and English grammar.

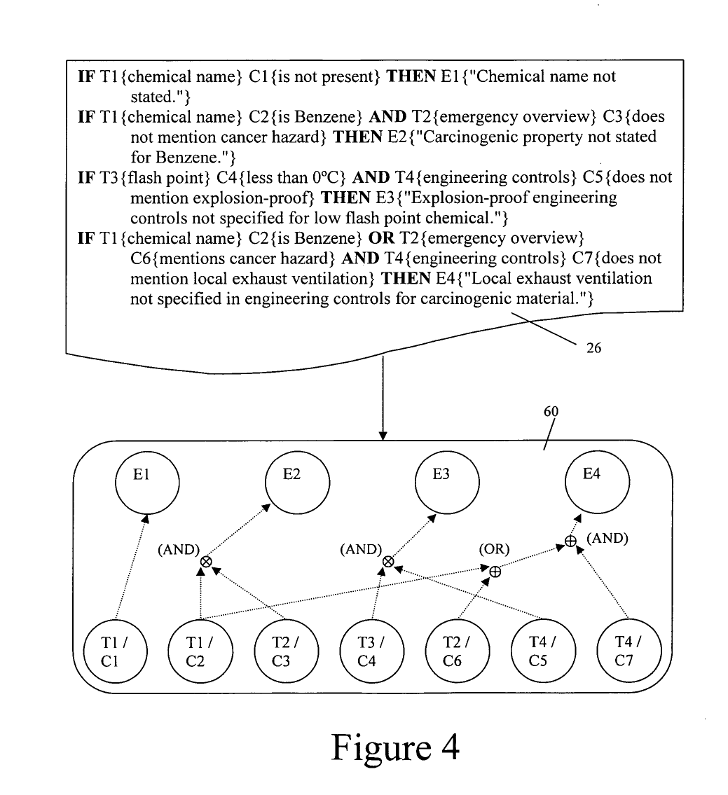

FIG. 4 presents a specific example of a specific logical network created from a specific set of validation rules. This specific set of rules is not an example of the generalised set of rules of FIG. 3, but is different. This logical network is an example of what might be created by step S36.

Whilst abstract representations of the terms T1, T2, T3 and T4 and conditions C1, C2, C3, C4, C5, C6 and C7 still appear in the logical network portion 60 of FIG. 4, they are, in fact, associated with actual terms and conditions such as are typically found within an actual chemical datasheet. Similarly, the abstract representations of the consequences E1, E2, E3 and E4 are associated with error messages that would be typically be produced upon the failure of the containing rule.

The actual terms of this example are as follows:
T1: {chemical name};
T2: {emergency overview};
T3: {flash point}; and
T4: {engineering controls}.

The actual conditions of this example are as follows:
C1: {is not present};
C2: {is Benzene};
C3: {does not mention cancer hazard};
C4: {less than 0° C.};
C5: {does not mention explosion proof};
C6: {mentions cancer hazard}; and
C7: {does not mention local exhaust ventilation}.

The actual consequences in this example are as follows:
E1: {“Chemical name not stated.”};
E2: {“Carcinogenic property not stated for Benzene.”};
E3: {“Explosion-proof engineering controls not specified for low flash point chemical.”}; and
E4: {“Local exhaust ventilation not specified in engineering controls for carcinogenic material.”}.

The specific set of validation rules 26, in the exemplary embodiment of FIG. 4, is in the form of a series of “IF-THEN” statements, which are as follows:

(i) IF T1 {chemical name} C1 {is not present} THEN E1 {“Chemical name not stated.”};

(ii) IF T1 {chemical name} C2 {is Benzene} AND T2 {emergency overview} C3 {does not mention cancer hazard} THEN E2 {“Carcinogenic property not stated for Benzene.”};

(iii) IF T3 {flash point} C4 {less than 0° C.} AND T4 {engineering controls} C5 {does not mention explosion-proof} THEN E3 { “Explosion-proof engineering controls not specified for low flash point chemical.”}; and

(iv) IF T1 {chemical name} C2 {is Benzene} OR T2 {emergency overview} C6{mentions cancer hazard} AND IF T4{engineering controls} C7{does not mention local exhaust ventilation} THEN E4 {“Local exhaust ventilation not specified in engineering controls for carcinogenic material.”}.

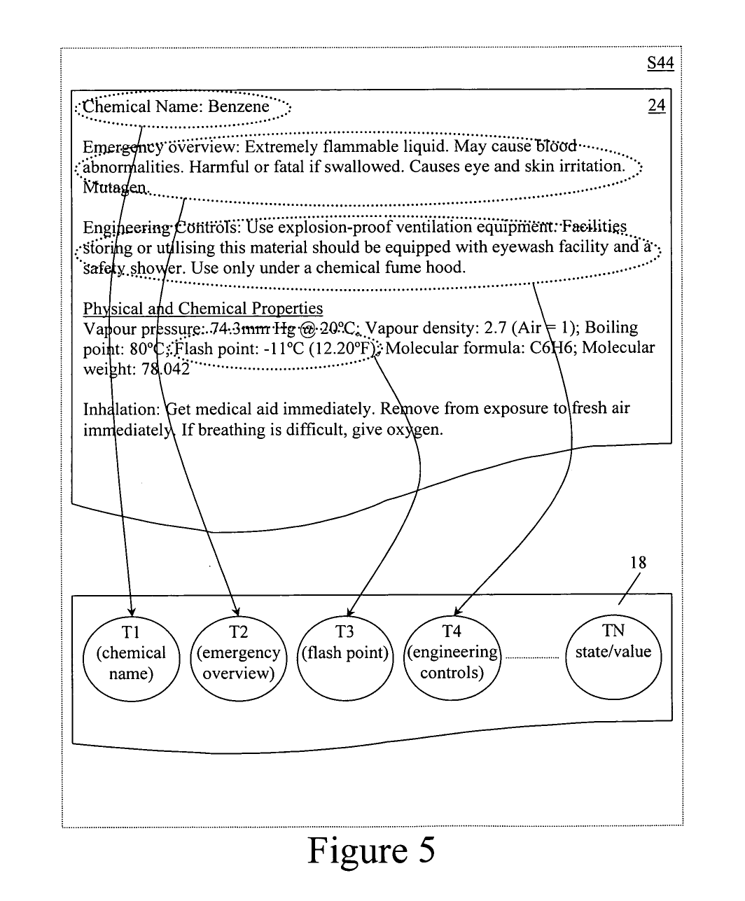

FIG. 5 depicts a schematic diagram illustrating an example of the information extraction portion of step S44 of FIG. 2 in more detail.

In FIG. 5, the document 24 represents the original form and contents of a document to be validated. Such content would most likely have been authored by one or more persons who are unrelated to the environment of the document validation system. As such, the different authors of different documents cannot be assumed to adopt the exact same formatting convention for all documents belonging to the same domain. By the application of the information extraction module 12 to the document 24, a consistent internal extracted meta-data representation 18 is obtained for each document to be processed by the system 10, regardless of the differences in layout and syntax that may have been adopted by their respective authors.

In this example, the document to be validated reads:
“Chemical Name: Benzene
Emergency overview: Extremely flammable liquid. May cause blood abnormalities. Harmful or fatal if swallowed. Causes eye and skin irritation Mutagen.
Engineering Controls: Use explosion-proof ventilation equipment. Facilities storing or utilising this material should be equipped with eyewash facility and a safety shower. Use only under a chemical fume hood.
Physical and Chemical Properties
Vapour pressure: 74.3 mm Hg@ 20° C.; Vapour density: 2.7 (Air=1); Boiling point: 80° C., Flash point: −11° C. (12.20° F.); Molecular formula: C6H6, Molecular weight: 78.042
Inhalation: Get medical aid immediately. Remove from exposure to fresh air immediately. If breathing is difficult, give oxygen.”

From this are extracted the meta-data information pairs:
T1: {chemical name} =“Benzene”;
T2: {emergency overview} =“Extremely flammable liquid. May cause blood abnormalities. Harmful or fatal if swallowed. Causes eye and skin irritation. Mutagen.”;
T3: {flash point} =“−11° C. (12.20° F.)”; and
T4: {engineering controls} =“Use explosion-proof ventilation equipment. Facilities storing or utilising this material should be equipped with eyewash facility and a safety shower. Use only under a chemical fume hood.”.

The first information pair is not extracted as T1: {chemical name} =“Chemical Name: Benzene”, because there is a normalisation of all different instantiations of the labels into a single form (i.e. “{chemical name} in this case), which is taken care of by the information extraction portion of the system.

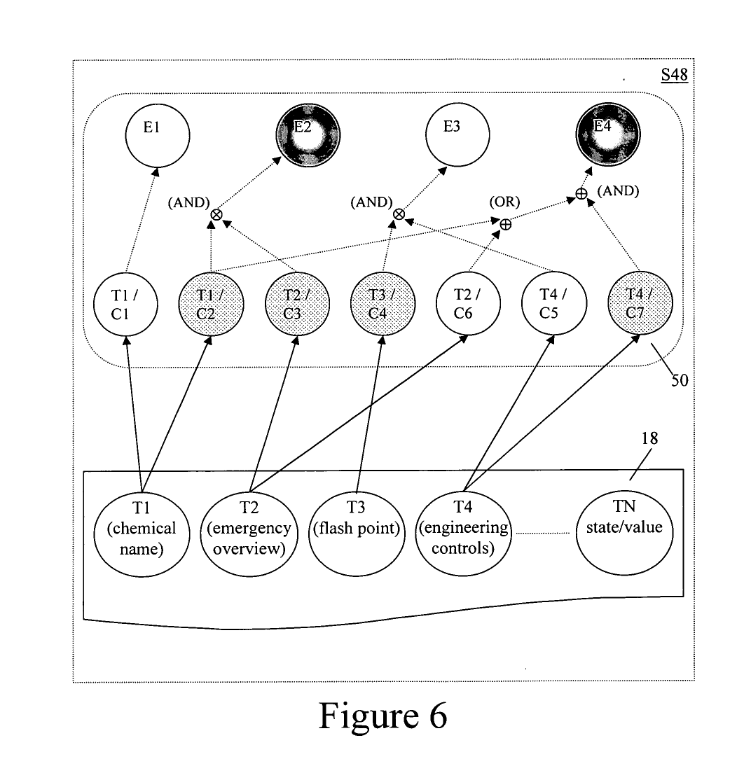

In the presently constructed inference engine 16, there are only four entity terms T1-T4. FIGS. 5 and 6 show the possibility of TN, as there can be any number as required.

FIG. 6 illustrates the operation of the logical network 60 of FIG. 4 on the extracted meta-data of FIG. 5, which corresponds to step S48 of the process of FIG. 2. The extracted meta-data 18 produced by the information extraction engine 12 in step S44 is propagated through the logical network 16 constructed by the rule interpreter 14 in step S36. The data extracted from the document in FIG. 5, with the logical network 60 of FIG. 4 provides a scenario where only the term-condition pairs T1/C2 [{chemical name} {is Benzene}], T2/C3 [{emergency overview} {does not mention cancer hazard}], T3/C4 [{flash point} {less than 0° C.}] and T4/C7 [{engineering controls} {does not mention local exhaust ventilation}] are activated. This is because the document 24 (in this case a chemical datasheet) mentions the name of chemical as benzene, fails to mention the carcinogenic properties of benzene, gives a flash point of −11 degrees Celsius for the chemical, and fails to instruct the use of local exhaust ventilation, thus satisfying conditions C2, C3, C4 and C7, respectively.

Conversely, the presence of the chemical name, the mention of the need for explosion-proof ventilation, and the absence of mention of chemical being carcinogenic, result in conditions C1, CS and C6 respectively not being satisfied. Condition C6 is in fact the complement of condition C3. Consequently, term-condition pairs T1/C1 [{chemical name} {is not present}],, T2/C6 [{emergency overview} {mentions cancer hazard}], and T4/C5 [{engineering controls} {does not mention explosion proof}] are not activated.

Observing the logical network 50 of FIG. 6, it can be seen that the lack of activation of the sole condition pair of rule (i) in the validation rule set 26 implies that consequence E1 is not triggered. However, the activation of all the term-condition pairs of rule (ii) in the validation rule set 26 implies that consequence E2 is definitely triggered. In contrast, the activation of only T3/C4 but not the other term-condition pair T4/C5 of rule (iii) implies that E3 is not triggered due to the requirement that both (i.e. AND relation) term-condition pairs must be satisfied. Finally, it can be seen that the consequence E4 of rule (iv) is triggered in spite of T2/C6 not being activated. This is because the OR relation between T1/C2 and T2/C6 means that even only one activated pair is sufficient to propagate an activation forward for further combination (AND) with the T4/C7 signal to trigger consequence E4.

Once the extracted meta-data content 18 has been completely propagated through the logic network 16, the next step S50 includes a straightforward perusal of all consequence nodes to determine which have been activated. For each activated consequence node, the associated term-condition pairs that failed can be traced back and recorded as well.

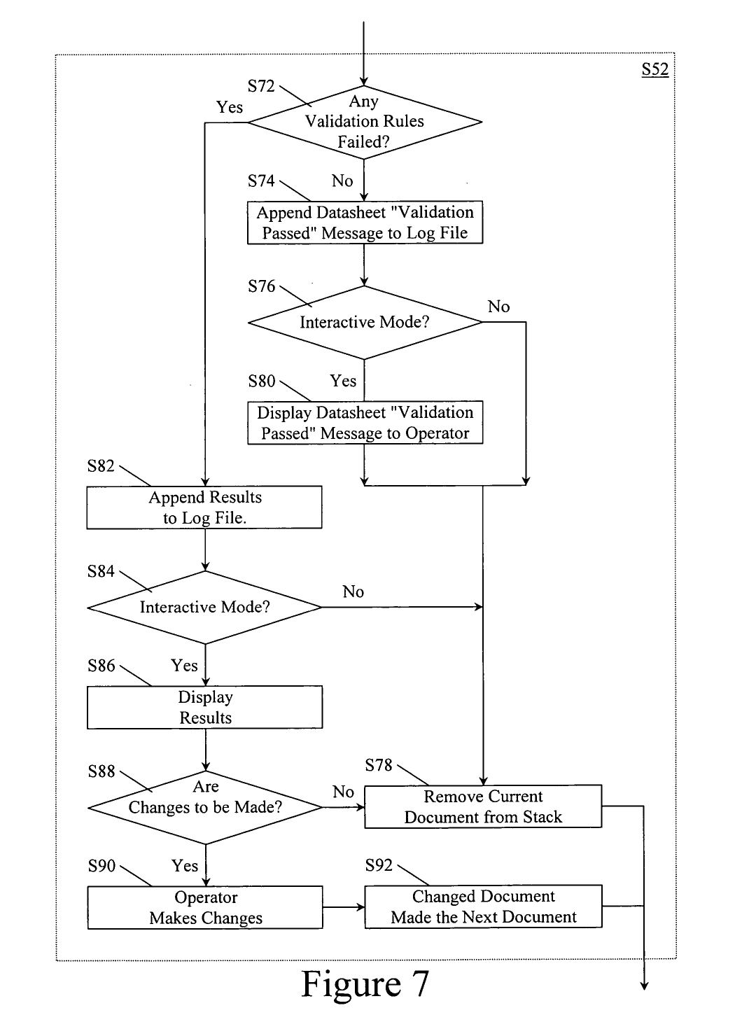

FIG. 7 is a detailed flowchart relating to an exemplary operation of step S52 of the process of FIG. 2. The appropriate actions are taken based on the presence of any triggered consequence. This process includes the consideration of whether the system is running interactively (i.e. with a human operator at hand) or not. This consideration is used to provide additional variations in the way that the validation failures are reported.

Based on the triggered consequences, a determination is made as to whether any validation rules have failed (step S72), that is whether any of the consequences El - E4 in the logical network 50 was triggered. Where no validation rules have failed for the present document, then a datasheet “validation passed” message is appended to a log file for this document (step S74). The process determines whether the system is in an interactive mode (step S76). If the system is not in an interactive mode, the current document is removed from the current stack of documents (step S78) and the process can proceed back to step S40 of the process of FIG. 2, where the document validation system is ready to perform validation on the next document for as many documents as are required. If the system is in interactive mode, a datasheet “validation passed” message is also displayed to a user on a graphical user interface (step S80) and the process then continues on to step S78), where the current document is removed from the current stack of documents, and the system can proceed back to step S40 of the process of FIG. 2.

Where one or more validation rules are ascertained as having failed in step S72, a paired list of invalid meta-data groups and the validation rules they failed are appended to log file for this current document (step 82). Again the process determines whether the system is in an interactive mode (step S84). If the system is not in an interactive mode, the current document is removed from the current stack of documents (step S78) and the process can proceed back to step S40 of the process of FIG. 2. If the system is in interactive mode, the extracted meta-data is displayed to the operator, on a standard template in a graphical user interface, together with error statements for those data for which an associated rule has failed (step S86).

The operator is preferably familiar with the domain and able to interpret the error message associated with each triggered consequence. He determines if he can or will make appropriate corrections or other changes to the document at this time, for instance, so that it would pass the validation (step S88). If none are to be made, the process proceeds to step S78 to remove the current document from the current stack of documents. Otherwise, if changes are to be made, then the changes are made to the document by the operator, usually to satisfy all the failed validation rules (step S90). The amended document is then left at the top of the current stack of documents (step S92) for resubmission to the validation engine, and the process can proceed back to step S40 of the process of FIG. 2.

In the process illustrated in FIG. 7, the log is written with the result whether or not the system is in interactive mode. In an alternative embodiment, the log is only written to with the results in non-interactive mode.

In the process illustrated in FIG. 7, the validation process stops every time a document fails one of the rules when the system is in the interactive mode. In a further alternative embodiment, the system moves onto the next document even when a document fails one of the rules when the system is in the interactive mode. Then when the operator has corrected the document it is slipped in as the next document at that point, rather than holding up the rest of the documents.

In the above embodiment, the rule base 26 and consequent inference engine 16 appear as fixed. However, there may also be provided one or more formatted external factual knowledge bases specific to the domain, by which the logical inference of the experts' rule base may be extrapolated to include new entities introduced into the domain.

In the above described embodiment, the process within the inference engine is represented as a decision tree. Embodiments of the invention are not limited to those where an inference engine process is or can only be so represented. For instance, they may allow for representations by other deterministic state transition graphs.

In the above example each entity is on a single level. The invention is also applicable to situations where one or more entities can have several levels: an upper level whose attribute is an entity on a sub-level (the attribute of the entity on a sub-level itself possibly being an attribute on a further sub-level etc.). The lower levels provide more detailed characteristics of the upper levels. As with the upper levels, the values on the sub-levels can vary too.

For instance, in another example, the document to be validated is a table of commodity prices for different producing countries. It has a list of countries along the vertical edge of the table, and three other column headings: “Produce”, “Livestock”, “Minerals” (upper level entities) along the horizontal edge. Under “Produce”, there are two sub-headings: “Vegetables” and “Fruit”; under “Livestock”, there are “Chicken”, “Fish” and “Cow”; and so on (lower-level entities). According to this table, at the highest level of abstraction there are attribute-value pairs: “Commodity” =“Produce” or “Livestock” or “Minerals”. At the next level of abstraction, there are attribute-value pairs of: “Produce” =“Vegetables” or “Fruit”; “Livestock” =“Chicken” or “Fish” or “Cow”; etc (for these pairs, “Produce” is also a component of an upper-level entity and “Vegetables” and “Fruit” are its sub-level entities). At a further level of abstraction, there are attribute-value pairs of “Chicken” =“$xxx”, “Fish” =“$yyy”, “Fruits” =“$ZZZ”, etc.

This means that at the top level of abstraction, the entities “Produce”, “Livestock” and “Minerals” describe the entity called “Commodity”. However, “Produce” also means the entities called “Vegetables” or “Fruit”. So in terms of validating such a table, there is a rule that requires the commodities to be sub-grouped into “Produce”, “Livestock” and “Minerals”, because there are general validation rules that apply to all produce, or all livestock or all minerals. However, there are also more specialised rules/conditions for example, “If“Commodity” =“Fish” then . . . ”. This rule is still entirely proper since “Fish” is ultimately one entity that describes “Commodity”, even though within the table there is no direct indication of such a pairing.

In the above description, components of the system are described as modules. A module, and in particular its functionality, can be implemented in either hardware or software. In the software sense, a module is a process, program, or portion thereof, that usually performs a particular function or related functions. In the hardware sense, a module is a functional hardware unit designed for use with other components or modules. For example, a module may be implemented using discrete electronic components, or it can form a portion of an entire electronic circuit such as an Application Specific Integrated Circuit (ASIC). Numerous other possibilities exist. Those skilled in the art will appreciate that the system can also be implemented as a combination of hardware and software modules.

Embodiments of the invention are applicable in many areas where a distinct class of products is required to have some non-trivial, item-specific documentation associated with each item in that class.

One example of such an area is the pharmaceutical industry and the packaged food industry, whereby complete and accurate product labelling is mandated. One advantage of applying an embodiment of the invention to these two domains is the ability to apply the most up-to-date knowledge in a consistent manner for evaluating all products within an industry. For example, if new scientific research shows that a particular food additive may be harmful, it would be easy, using a relevant embodiment, to re-assess the safety of existing products, any number of which may have had their compositions modified since a previous assessment.

As another example, the area of health care is one that embodiments of the invention can bring significant benefits to. In this domain, medication fact sheets may represent one set of data to be analysed, patient records represent another. A suitable embodiment can then be applied consistently to any one pair of medication fact sheet and patient record, in a process of cross-validation, to alert health workers automatically to any potential allergic reactions.

A suitable embodiment of the invention can also be applied in the area of financial analysis, wherein it will be able to provide more exact information capture than a normal news filtering apparatus. This is because the latter is only able to highlight news articles mentioning a subject of interest to the user (e.g. a particular company's stock or a certain country's economy) but is not able to provide more specific details of the subject (e.g. the particular company's stock price has risen to a certain level, the economic growth forecast for the certain country's has been lowered to 1%). It still left to the user to sift through the news articles filtered through to determine the details. Given that the subject of interest may appear in many different contexts, this means that the user is still in danger of suffering from information overload. By applying a suitable embodiment of the invention to the analysis of financial news, users would be able to filter out many articles that are not specific enough for their interests, and even be provided with alerts to those mentioning particular quantitative events.

As a further example, in the area of materials safety data sheet (MSDS) validation a suitable embodiment of the invention may have particular applicability (as is illustrated with respect to FIGS. 4 to 6). MSDSs are data sheets that are associated with each and every chemical product that is produced by any manufacturer in the chemicals industry. They contain such information as a chemical's components, its physical and chemical properties, protective equipment required for its safe handling, first aid measures in event of exposure, transportation requirements and much more. Occupational safety and health regulations in many countries require that all MSDSs satisfy specific levels of correctness and completeness for their contents and how up-to-date their content are. However the vast number of new or revised MSDSs that are constantly being released make it impossible for the small number of occupational health officers possessing the necessary specialist knowledge to check every one of the data sheets. The officers must thus presently rely on sampling and, consequently, many MSDSs of insufficient quality are released to workers in the chemical industry. Through the application of a suitable embodiment of the invention, the combined problem of information overload and insufficient expertise manpower in the problem domain of MSDS validation can be overcome or at least alleviated.

The above described embodiments are directed toward validating the contents of documents, particularly technical documents. The embodiments of the invention are able to do so using several variants in implementation. From the above description of a specific embodiment and alternatives, it will be apparent to those skilled in the art that modifications/changes can be made without departing from the scope and spirit of the invention. In addition, the general principles defined herein may be applied to other embodiments and applications without moving away from the scope and spirit of the invention. Consequently, the present invention is not intended to be limited to the embodiments shown, but is to be accorded the widest scope consistent with the principles and featured disclosed herein.

We claim:

1. A method for performing content validation on a free-text document, the method comprising:
extracting a plurality of semi-structured representations from the free-text document;
applying a logical inference engine to the semi-structured representations; and
interpreting the output of the logical inference engine for a consequential action.

2. A method according to claim 1, wherein the document is a technical document.

3. A method according to claim 1 wherein the consequential action involves one or more of:
providing an indication that the content of the document is valid;
relating any of the validation rules that have failed; and
revising content of the document based on any of the validation rules that have failed

4. A method according to claim 3, wherein relating any of the validation rules that have failed comprises relating and highlighting to a human operator any of the validation rules that have failed.

5. A method according to claim 3 wherein relating any of the validation rules that have failed further comprises relating the associated semi-structured representations or corresponding original content of the document.

6. A method according to claim 3, wherein revising content of the document is further based on corresponding original content of the document.

7. A method according to claim 1, wherein the semi-structured representations comprise discrete entities and their attributes.

8. A method according to claim 7, wherein the attributes of the discrete entities comprise qualitative, quantitative or logical attributes, or their relationships with other entities.

9. A method according to claim 7 wherein the discrete entities each corresponds directly to a physical or abstract concept as defined in a written language.

10. A method according to claim 7, wherein one or more of said entities comprise upper-level entities, the attributes of which represent lower-level entities, providing more detailed characteristics about their respective upper-level entity.

11. A method according to claim 1, wherein the logical inference engine is constructed from a list of structured validation rules.

12. A method according to claim 11, further comprising constructing the logical inference engine from the list of structured validation rules.

13. A method according to claim 11 wherein the structured validation rules are specified by an authority in the domain of the document.

14. A method according to claim 13, wherein the domain authority comprises one or more of the group consisting of: a human expert, a book, and other authoritative sources of information.

15. A method according to claim 1, wherein the logical inference engine comprises an inference network.

16. A method according to claim 1, wherein the logical inference engine comprises a process that can be represented as a decision tree, or another deterministic state transition graph representation.

17. A method according to claim 1, wherein the free-text documents comprise one or more of the group consisting of: text, image, audio and video.

18. A method according to claim 1, wherein the list of structured validation rules comprises a list of conditional statements written in a formal declarative language.

19. A method according to claim 18, wherein each of the conditional statements comprises an antecedent part and a consequence part.

20. A method according to claim 19, wherein the antecedent part comprises a list of a number of independent conditional tests that are logically combined through a sequence of “AND”, “OR” or “NOT” logic operations.

21. A method according to claim 20, wherein each conditional test comprises a logical, relational, quantitative or qualitative constraint applied to relevant entities within the domain.

22. A method according to claim 1, wherein the consequence part comprises one or more of the group consisting of: a set of entities to be highlighted, an error message to be displayed and a corrective action to be taken.

23. A method according to claim 1, further comprising displaying one or more of the group consisting of: the semi-structured representations, the list of validation rules, the relationship between the semi-structured representations and the validation rules, and the highlights between the semi-structured representation or original content of the text documents and any validation rules they have failed.

24. A method according to claim 1, further comprising obtaining user instructions in terms of any one or more of the group consisting of: new validation rules, revised validation rules, and revised document content.

25. A system for performing content validation on a free-text document, the system comprising:
means for extracting a plurality of semi-structured representations from the free-text document;
means for applying a logical inference engine to the semi-structured representations; and
means for interpreting the output of the logical inference engine for a consequential action.

26. A system according to claim 25, further comprising means for providing an indication that the content of the document is valid, as a consequential action.

27. A system according to claim 25 further comprising means for relating any of the validation rules that have failed, as a consequential action.

28. A system according to claim 25, further comprising means for revising content of the document based on any of the validation rules that have failed, as a consequential action.

29. A system according to claim 25, wherein the semi-structured representations comprise discrete entities and their attributes.

30. A system according to claim 29, wherein the attributes of the discrete entities comprise qualitative, quantitative or logical attributes, or their relationships with other entities.

31. A system according to claim 29 wherein the discrete entities each corresponds directly to a physical or abstract concept as defined in a written language.

32. A system according to claim 29, wherein one or more of said entities comprise upper-level entities, the attributes of which represent lower-level entities, providing more detailed characteristics about their respective upper-level entity.

33. A system according to claim 25, further comprising the logical inference engine.

34. A system according to claim 33, wherein the logical inference engine is constructed from a list of structured validation rules.

35. A system according to claim 33 further comprising means for constructing the logical inference engine from the list of structured validation rules.

36. A system according to claim 25, wherein the logical inference engine comprises an inference network.

37. A system according to claim 25, wherein the logical inference engine comprises a process that can be represented as a decision tree, or another deterministic state transition graph representation.

38. A system according to claim 25, operable when the free-text documents comprise one or more of the group consisting of: text, image, audio and video.

39. A system according to claim 25, wherein the list of structured validation rules comprises a list of conditional statements written in a formal declarative language.

40. A system according to claim 39, wherein each of the conditional statements comprises an antecedent part and a consequence part.

41. A system according to claim 40, wherein the antecedent part comprises a list of a number of independent conditional tests that are logically combined through a sequence of “AND”, “OR” or “NOT” logic operations.

42. A system according to claim 41, wherein each conditional test comprises a logical, relational, quantitative or qualitative constraint applied to relevant entities within the domain.

43. A system according to claim 40, wherein the consequence part comprises one or more of the group consisting of: a set of entities to be highlighted, an error message to be displayed and a corrective action to be taken.

44. A system according to claim 40, further comprising storage means for storing the semi-structured representations.

45. A system according to claim 40, further comprising a user interface.

46. A system according to claim 45, wherein the user interface is operable to display data to an operator.

47. A system according to claim 45 wherein the user interface is operable to input user instructions in terms of new validation rules, revised validation rules, or revised document content.

48. A method of performing content validation on a free-text document substantially as hereinbefore described with reference to and as illustrated in the accompanying drawings.

49. A system according to claim 25, operable according to the method of any one of claims 1 to 24 and 48.

50. A system for performing content validation on a free-text document constructed and arranged substantially as hereinbefore described with reference to and as illustrated in the accompanying drawings.

51. A computer program product having a computer usable medium having a computer readable program code means embodied therein for performing content validation on a free-text document, the computer program product comprising:
computer readable program code means for operating according to the method of claim 1.

52. A computer program product having a computer usable medium having a computer readable program code means embodied therein for performing content validation on a free-text document, the computer program product comprising:
computer readable program code means which, when downloaded onto a computer renders the computer into a system according to claim 25.
